(19) United States
(12) Patent Application Publication
(10) Pub. No.: US 2015/0308429 A1
(43) Pub. Date: Oct. 29, 2015

(54) METHOD AND APPARATUS FOR TRANSPORTING VISCOUS MATERIAL

(71) Applicant: UPM-KYMMENE CORPORATION, Heksubju (FI)

(72) Inventors: Juha Tamper, Taipalsaari (FI); Isko Kajanto, Espoo (FI); Maria Alajaaski, Rauma (FI); Taisto Tienvieri, Vantaa (FI); Markus Nuopponen, Helsinki (FI)

(21) Appl. No.: 14/647,584

(22) PCT Filed: Dec. 4, 2013
(86) PCT No.: PCT/FI2013/051132

§ 371 Date: May 27, 2015

(30) Foreign Application Priority Data
Dec. 4, 2012 (FI) 20126268

(51) Int. Cl. F04C 13/00; F04C 2/107; B67D 7/02

(52) U.S. Cl. CPC F04C 13/001; B67D 7/0277; F04C 2/107

(57) ABSTRACT

In a method for transporting nanofibrillar cellulose in the form of viscous liquid dispersion, the nanofibrillar cellulose is unloaded from a container (3) through a discharge point (3b) which is the lowermost point with respect to the volume of nanofibrillar cellulose in the container at least at the time of unloading. The nanofibrillar cellulose is unloaded and transported to a target location along a pipe (2) using a progressive cavity pump (P2) operating on a positive displacement principle with the suction side of the pump at a distance from the discharge point (3b). The discharge of the nanofibrillar cellulose is ensured by
selecting the distance (L) of the suction side of the pump (P2) from the discharge point (3b) so short that the nanofibrillar cellulose flows from the container (3) by the effect of the pump suction, or
pressurizing the nanofibrillar cellulose in the container (3) to such a pressure (p) that it will flow at the selected distance (L) of the suction side from the discharge point by the common effect of the pressure of the nanofibrillar cellulose and the pump suction.

### FIELD OF THE INVENTION

The present invention relates to a method for transporting viscous material. The invention also relates to an apparatus for transporting viscous material.

### BACKGROUND OF THE INVENTION

Nanofibrillar cellulose is, as a rule, made from fibrous raw material by disintegrating it into fibrils. The process takes place in a fibrous suspension at a relatively low consistency. Consequently, the resulting nanofibrillar cellulose is a liquid dispersion with a correspondingly low concentration. The concentration of the nanofibrillar cellulose in the dispersion is usually below 5 wt-%, usually about 1 to 4 wt-%.

One of the most prominent physical properties of the nanofibrillar cellulose is that it forms a highly viscous gel in concentrations above 1%. Difficulties arise when the nanofibrillar cellulose is to be handled for transportation in consistencies above 1%, and the difficulties related to viscosity in typical high-viscosity grades are directly proportional to the concentration. In a concentration of about 1%, a usual tank truck with carrying capacity of about 44 tons can thus transport only 440 kg of nanofibrillar cellulose, expressed as dry substance. By simple calculation it can be deduced that raising the concentration two- or three-fold (to 2 or 3%) would mean a transporting capacity of over about 880 to 1320 kg nanofibrillar cellulose as dry substance.

Nanofibrillar cellulose dispersion can be transported at higher concentrations in barrels. However, handling individual barrels requires a lot of work, and especially filling and emptying the barrels is time-consuming.

Another problem is connected with the transport of nanofibrillar cellulose from a large container to a point where it is to be processed or stored or transported further, when this large container is unloaded. The distance from the container to the other point may be only some meters, but the high viscosity makes it difficult to empty the container. Pumping has proved difficult because the large volume of viscous mass in the container resists very effectively suction by pump.

Drying would be another alternative for handling and transporting nanofibrillar cellulose, which then can be redispersed at the site of use. However, this is not always the best alternative because of the time and energy involved, especially if the nanofibrillar cellulose is to be used relatively soon after the production and/or the site of use is at such a relatively short distance from the site of production that the transport costs of liquid dispersion will not be too high. This is especially the case if the nanofibrillar cellulose at the site of use is used in the same form as it was produced, that is, in the form of liquid dispersion. In practice, because of pumping difficulties during unloading, high-viscosity grades of nanofibrillar cellulose can be transported at a concentration of 1% at most in large containers, which increases the transport costs per ton of dry matter considerably.

### SUMMARY OF THE INVENTION

It is the purpose to provide a method for transport of nanofibrillar cellulose (NFC) along a pipe using a pump from a container to a target location, such as a point of use, point of storage or point of further transport.

By a suitable combination of a pump, short suction distance between the suction side of the pump and discharge point of the nanofibrillar cellulose from the container, as well as the shape of the volume of nanofibrillar cellulose in the interior of the container at the time of unloading the container, it is possible to discharge the viscous mass of nanofibrillar cellulose from the container and transport it along a pipe to the target location.

The inner volume of the container that contains the viscous mass of nanofibrillar cellulose has the discharge point at its lowermost point at least at the time of unloading. Further, the distance from the discharge point to the suction side of the pump is chosen so short that the nanofibrillar cellulose that exists in the container as large-volume viscous mass will flow by the suction of the pump out of the container possibly aided by external pressure exerted on this volume. The distance of the suction side and the discharge point, depending on the viscosity properties of the NFC and e.g. the diameter of a pipe connecting the pump and the discharge point, is 0-10 m, 0-9 m, 0-8 m, 0-7 m, 0-6 m, 0-5 m, 0-4 m, 0-3m, 0-2 m, or 0-1 m, as measured along said pipe. Preferably said distance is 0-5 m, 0-4 m, 0-3 m, 0-2 m, or 0-1 m, especially when the NFC in the container is not pressurized. In one embodiment, the distance is 3 m at the most, more preferably not longer than 2 meters, preferably 1 meter or less.

In cases where pressure can be used, the distance can be 0-10 m, 0-9 m, 0-8 m, 0-7 m, or 0-6 m, it being understood that distances not longer than 3 m may be preferable also in this case.

The suction side of the pump can be connected directly to the discharge point without a connecting pipe, if the pump is eqipped with suitable coupling means allowing this direct attachment. In this case the distance can be regarded as 0 m, without a connecting pipe that has a characteristic flow resistance.

The pump is a progressive cavity pump, known also as “Mono-pump” which can produce an even volumetric flow without pulsations.

Pressure can be used as an aid to urge the mass from the container. The pressure is effective above the mass of nanofibrillar cellulose and it is preferably a gaseous pressure. Air is preferably used as the gaseous medium that is pressurized, which can be done by a compressor.

The pipe for the transport of the nanofibrillar cellulose is preferably a flexible hose having sufficiently large diameter: The diameter is preferably at least 50 mm both between the discharge point and the pump and between the pump and discharge end of the pipe at the target location. The diameters need not be equal on both sides of the pump. More preferably the diameter between the discharge point and the suction side is at least 75 mm.

It is still another purpose to provide a method which enables the handling and transporting of nanofibrillar cellulose in large integral volumes (typically 10 m³ or higher) at higher, more viscous concentrations than has been possible until today. The transport is performed by a vehicle in a container that has a tapering portion towards a discharge outlet which will form the lower end of the container at least in one operational position of the container. The container can be a tippable container where the outlet will be in the lowest position with respect to the interior of the container at the time of tipping. The container can be part of the vehicle or it can be a movable container which can be placed in a vehicle. When the container is integrated in the vehicle at the time of loading, transport and unloading, the vehicle can be a tipping tanker truck. The vehicle can also be a tanker truck where the container is in fixed position but it has the tapering portion pointing downwards with the discharge outlet always in the lowest position with respect to the inner volume of the container, that is, the tanker truck can be emptied at the underside of the container. The container can be provided with functions for unloading the volume of viscous nanofibrillar cellulose from the interior of the container. In case of a tipping container in a vehicle, the tapering rear end of the container comprises a discharge outlet, which will be at the lowest position after the completion of the tipping, or if the container is always in horizontal position, it has the discharge outlet always at the lowest position under the container. During the unloading operation, the interior volume of the tipped container is subjected to pressure, and a pump which is external to the container is used for pumping the nanofibrillar cellulose dispersion from the container through the discharge outlet. The unloading of the viscous mass proceeds with the combined action of three forces: gravity due to the tipped position of the container, pressure that pushes the mass out of the container, and a pump that causes suction that draws the mass from the container.

The same possibilites for emptying the container can be provided in a railway car. The rail tank wagons have the containers usually in fixed horizontal position, in which case the discharge outlet is always at the lowest position under the container.

The container can be also movable as such to or from a vehicle. In this case the vehicle can be a terrestial vehicle or even a ship.

In all containers whose position with respect to the horizontal level is not alterable for unloading, the discharge point is always at the lowermost point with respect to the volume of the nanofibrillar cellulose, that is, the inner volume of the tank determining the shape of the volume of the nanofibrillar cellulose. This can be achieved by shaping the container so that its interior volume has a downward tapering portion which ends at the discharge point.

The pump used is preferably a progressive cavity pump, which is a helical rotor pump which operates on the positive displacement principle. This type of pump is also known as eccentric screw pump or “Mono pump”. Compared with for example a centrifugal pump, this kind of “mono pump” is able to produce a high pressure, which is useful when the pumping distance to the discharge point (storage container) is long. This pump can also effectively draw the nanofibrillar cellulose from the container.

The loading of the empty container, which can be integrated in a road vehicle or railway car or be a movable container, or a stationary container at the site of use or storage, takes place preferably through a filling inlet at the top of the container, such as an upper hatch. The filling through the top is easier than the use of the discharge outlet, which in a lower position would have the counterpressure caused by the mass of the material as drawback.

### DESCRIPTION OF THE DRAWINGS

The method will be described in the following with reference to the accompanying drawings, where

FIG. 1 illustrates the loading stage,

FIG. 2 illustrates the unloading stage, and

FIG. 3 shows the functional principle of a pump used in the method.

### DETAILED DESCRIPTION OF PREFERRED EMBODIMENTS

The nanofibrillar cellulose handled by the method is a dispersion of cellulose fibrils in liquid medium, usually water. Nanofibrillar cellulose refers to a collection of isolated cellulose microfibrils or microfibril bundles derived from cellulose raw material. Nanofibrillar cellulose has typically a high aspect ratio: the length might exceed one micrometer while the number-average diameter is typically below 200 nm. The diameter of nanofibril bundles can also be larger but generally less than 5 μm. The smallest nanofibrils are similar to so called elementary fibrils, which are typically 2-12 nm in diameter. The dimensions of the fibrils or fibril bundles are dependent on raw material and disintegration method. The nanofibrillar cellulose may also contain some hemicelluloses; the amount is dependent on the plant source. Mechanical disintegration of nanofibrillar cellulose from cellulose raw material, cellulose pulp, or refined pulp is carried out with suitable equipment such as a refiner, grinder, homogenizer, colloider, friction grinder, ultrasound sonicator, fluidizer such as microfluidizer, macrofluidizer or fluidizer-type homogenizer.

The nanofibrillar cellulose is preferably made of plant material. One alternative is to obtain the fibrils from non-parenchymal plant material where the fibrils are obtained from secondary cell walls. One abundant source of cellulose fibrils is wood fibres. The nanofibrillated cellulose is manufactured by homogenizing wood-derived fibrous raw material, which may be chemical pulp. The disintegration in some of the above-mentioned equipments produces fibrils which have the diameter of only some nanometers, which is 50 nm at the most and gives a dispersion of fibrils in water. The fibrils can be reduced to size where the diameter of most of the fibrils is in the range of only 2-20 nm only. The fibrils originating in secondary cell walls are essentially crystalline with degree of crystallinity of at least 55%.

The nanofibrillar cellulose that is handled by the method can also be chemically modified nanofibrillar cellulose. One example is is nanofibrillar cellulose containing anionically charged groups (anionically charged nanofibrillar cellulose). Such anionically charged nanofibrillar cellulose can be for example chemically modified cellulose that contains carboxyl groups as a result of the modification. Cellulose obtained through N-oxyl mediated catalytic oxidation (e.g. through 2,2,6,6-tetramethyl-1-piperidine N-oxide) or carboxymethylated cellulose are examples of anionically charged nanofibrillar cellulose where the anionic charge is due to a dissociated carboxylic acid moiety. Anionically charged nanofibrillar cellulose is typically produced by modifying pulp chemically, whereafter the fibres of the pulp are disintegrated to nanofibrillar cellulose.

The chemically modified nanofibrillar cellulose can also be nanofibrillar cellulose containing cationically charged groups. Such cationically charged nanofibrillar cellulose can be for example chemically modified cellulose that contains quaternary ammonium groups as a result of the modification. Cationically charged nanofibrillar cellulose is typically produced by modifying pulp chemically, whereafter the fibres of the pulp are disintegrated to nanofibrillar cellulose.

The most difficult phase in the transport chain of the nanofibrillar cellulose is the unloading of the viscous mass formed by the aqueous dispersion of nanofibrillar cellulose (to be called hereinafter simply “nanofibrillar cellulose” or “NFC”) from a container and supplying it along a pipe to a target location. The difficulty is related to the large zero-shear viscosity of nanofibrillar cellulose. It can be said that NFC grades having a zero-shear viscosity above 5000 Pa·s, especially above 10000 Pa·s, when measured at a concentration of 1 wt-% in aqueous dispersion by rotational rheometer are difficult to handle. Zero shear viscosity is the viscosity value in a region of constant viscosity at small shear stresses when the shear stresses approach zero. This variable characterizes well the “stiffness” of NFC in static condiction. The yield stress of difficult NFC grades is usually above 3 Pa when measured at a concentration of 1 wt-%. The yield stress is the stress at which the shear-thinning behaviour of the NFC starts (detected through abrupt drop of viscosity) when the viscosity is measured at increasing shear stresses.

In real situations, however, the transport difficulty is related to the rheological properties at the processing consistency. As a rule, a viscous nanofibrillar cellulose dispersion the zero-shear viscosity above 10000 Pa·s, especially above 20000 Pa·s, when determined by rotational rheometer at processing consistency (consistency at which it is pumped) can be characterized as “difficult”, irrespective of the consistency, which could be even below 2 wt-%.

When a container containing a volume of NFC is to be unloaded, it can be a container that has been transported to the place of unloading by some means of transport. In this case the target location to which the NFC is supplied from the container along a pipe by pumping can be a point of use (a process), a point of storage, or a point of further transport. In all these cases the point to which the NFC is supplied can be another container. In the point of use the container can be a process container, in the point of storage it can be a storage container, and in the point of further transport the container can be a transportable container. The transportable container can be a part of a road vehicle or railway car, or it can be freely movable, such as a freight container.

The container from where the unloading takes place may also be a stationary container, for example at a production site. In this case the contents of the container are usually unloaded to a point of further transport, that is, another container which is then transported by some means of transport as explained above. It is also possible that the target location to which the NFC is supplied along a pipe by pumping can be another fixed container at the same production site. In this ase the transport takes place between two fixed containers.

In the following, the method will be explained with reference to a road vehicle provided with a tippable container, but the method can be applied in analogical manner in all other vehicles and container types. If the container is not tippable, its unloading takes place in analogical manner through a discharge outlet that is at the lowest position in the inner volume of the container. The storage container shown in the following embodiment is an example of such a container.

The nanofibrillar cellulose, which has been manufactured by any method into a nanofibrillar cellulose dispersion in water and exists prior to loading in the form of aqueous dispersion in concentration of about 2 to 5 wt-% on the basis of the weight of the dispersion, is loaded to a tippable container 3 of a tank truck T. The loading takes place from an intermediary storage container 1, which has a downwards tapering bottom to facilitate the discharge of the dispersion through the discharge outlet at the lower end of the bottom. Thus, the lowermost point of the inner volume of the container is the discharge outlet 1b (discharge point) so that all NFC in the container 1 will run through the discharge outlet aided by gravity. A filling pump P1 pumps the dispersion to the container 3 of the tank truck T through a connecting hose 2. The distance L from the discharge outlet 1b to the suction side of the pump P1, when measured along the connecting hose section between the discharge outlet 1b and the pump P1, is kept as short as possible, preferably not longer than 2 m, more preferably 1 m or less. The distance from the pressure side of the pump P1 to the discharge end of the connecting hose may be longer, but it is preferably not longer than 20 m. Alternatively to using this short length L between the discharge outlet and the pump or additionally to it, the container 1 is pressurized (pressure p) so that an overpressure above the level of NFC dispersion inside the tank aids the flow of NFC towards the discharge outlet 1b. The pressure is a gaseous pressure above 1 bar (preferably 1.5-2 bar). The pressure can be effected by a compressor. The tank truck container 3 is filled through a filling inlet 3a at the top of the container when the container is in untipped (in horizontal) position. The filling inlet 3a is the upper hatch through which the hose 2 is introduced. After the loading is complete, the tank truck T drives to the destination.

As stated above, the distance from the container to the pump can be longer if pressure is used to urge the NFC from the container 1. The distance, depending on the pressure level and the diameter of the hose, can be up to 6 m or even longer.

Concentrations of NFC in the range of 2 to 5 wt-% were mentioned above. However, the nanofibrillar cellulose can be even at a higher concentration if it is of a grade that produces lower viscosity, up to 6 wt-% or even up to 8 wt-% based on the weight of the aqueous dispersion.

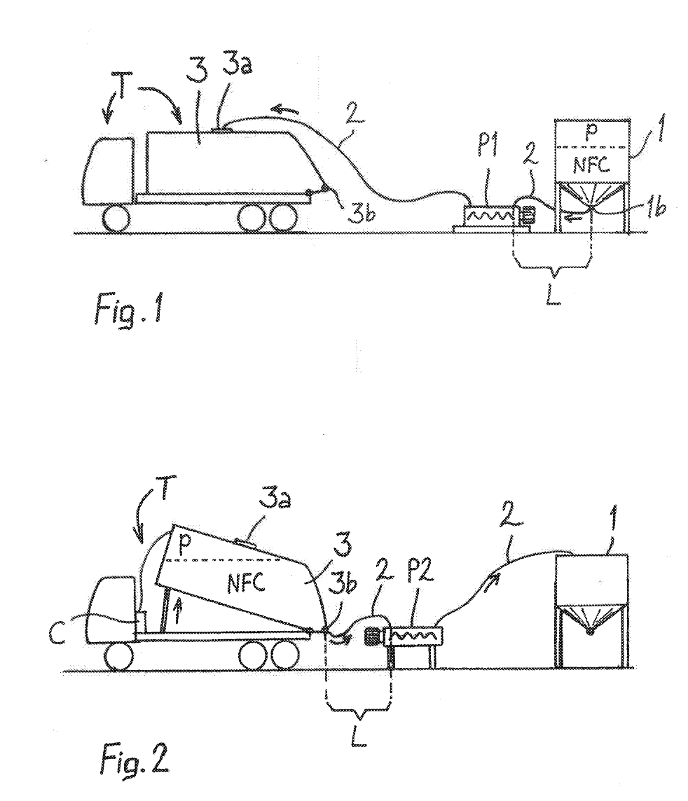

FIG. 2 illustrates the unloading stage at the destination, which is usually the site of use, but can be also storage facilities, from where the nanofibrillar cellulose will be transported further. The critical unloading step uses three different means which aid in discharging the contents of the container as in the filling stage of FIG. 1: gravity, now by tipping the container so that the discharge outlet will be at the lowest position, pressurization of the inner volume of the container, and mechanical conveying means of the dispersion outside the container comprising a pump whose distance from the discharge outlet is minimized.

The container 3 of the truck is tipped by the own mechanism of the tank truck T so that the rear end of the container, which is tapering, points downwards. A discharge pump P2 is connected to the discharge outlet 3b of the container 3 through a hose 2, the valve of the discharge outlet 3b is opened, and the inside of the container is pressurized to an overpressure, for example 1.5 to 2 bar absolute pressure (denoted by p) by a compressor C, which can be the own compressor of the vehicle. The pressure drives the suspension in the container towards the discharge outlet 3b, from which the discharge pump P2 draws the dispersion to an intermediary storage container 1 at the location. This intermediary storage container may also have a downwards tapering bottom to facilitate its unloading for further handling of the nanofibrillar cellulose, for the transport of the nanofibrillar cellulose to the next process step for example.

In freely movable containers such as freight containers, which can be moved from one transport vehicle to another during the transport chain and transported in a ship on sea, the driving pressure at the time of unloading can be even higher, between 2 and 4 bar.

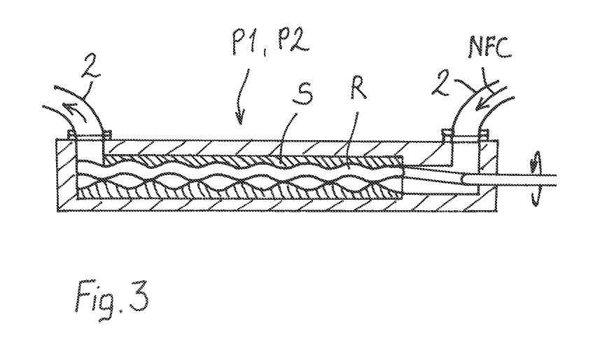

FIG. 3 shows the functional principle of a pump that can be used in the method. Both the filling pump P1 at the site of loading and the discharge pump P2 at the site of unloading in the destination are preferably helical rotor pumps which give a positive displacement of the liquid dispersion (so-called mono pump). This type of pump can handle large amounts of viscous liquids, and it has a rotating helical rotor R in a helical stator S, which together create a progressing cavity advancing in front of a continuously forming seam line (hence the denomination “progressive cavity pump”), thus carrying the dispersion to be pumped to the pressure side of the pump. The power of the pump is also sufficient to pump the NFC over a long distance on the pressure side towards the discharge end of the hose 2.

The connective hose 2 between the pump and the truck container 3 in the loading stage and unloading stage has preferably a large diameter, for example at least 50 mm, preferably at least 75 mm. Further, it is preferred that the length of the hose 2 between the discharge outlet 3b and the discharge pump P2 is as short as possible in the unloading stage (preferably 2 m at the most, more preferably not longer than 1 m), so that there would be not too much suction work to lower the capacity of the discharge pump P2. The connective hose 2 between the intermediate container and the pump in the loading stage and the unloading stage has preferably the same large diameter of at least 50 mm, preferably at least 75 mm.

The method is suitable for nanofibrillar cellulose concentrations of about 2 to 5 wt-% of the total weight of the dispersion, which is usually the concentration at which the nanofibrillar cellulose exists right after the manufacturing of the nanofibrillar cellulose through fibrillating disintegration of the fibrous suspension raw material. However, it is possible that the dispersion to be handled by the method is in a higher concentration if the manufacturing method so allows, or has been subjected to preliminary liquid removal before the transport.

The filling pump P1 and the discharge pump P2 can be available at the site of loading and unloading, respectively. However, it is possible that if the container is integrated in a vehicle, the vehicle itself is equipped with a pump which can be used both as filling pump and discharge pump.

The tank truck can be of any type: the container mounted on its chassis, the container on a semitrailer, or the container on a full trailer.

### Example

Catalytically (“TEMPO”) oxidized pulp was disintegrated to nanofibrillar cellulose and introduced to two conical bottom containers having each a capacity of 5 m³, the total volume of the nanofibrillar cellulose batch being 10 m³ and the concentration 2.4 wt-%. The viscosity of the batch was 21000 mPa·s at the concentration of 0.8 wt-% (Brookfield, 10 rpm).

The tank truck was a vehicle provided with a tippable container whose rear end was tapering to an apex where a discharge outlet valve was located. The maximum capacity of the container was was 60 m³.

The container was filled through the upper hatch from the two conical bottom containers using a Mono pump with 2 inch inner diameter (about 5 cm) connecting hose, length 20 m. The container was discharged by tipping the container, connecting a discharge hose of 4 inch inner diameter (about 10 cm) and 5 m length between the rear end discharge outlet and a Mono pump, opening the discharge outlet valve, starting the pump and pressurizing the container to a pressure of 2 bar with a compressor of the vehicle. The pumping distance from the pump to the receiving container was 20 m and the hose on this pressure side had 3 inch inner diameter (about 7.5 cm). The pumping output was 500 l/min, which was the emptying rate of the container. The method is not limited to the use of road vehicles for transport. The containers can be transported by any means on roads, on railroads or on sea.

1. Method for transporting viscous material which is nanofibrillar cellulose in the form of liquid dispersion showing shear thinning behaviour and having zero-shear viscosity above 10000 Pa·s at the processing consistency in the container when determined by rotational rheometer, said method comprising:
unloading the nanofibrillar cellulose from a container through a discharge point which is the lowermost point with respect to the volume of nanofibrillar cellulose in the container at least at the time of unloading,
unloading and transporting the nanofibrillar cellulose to a target location along a pipe using a progressive cavity pump operating on a positive displacement principle with the suction side of the pump at a distance from the discharge point, and
ensuring the discharge of the nanofibrillar cellulose by
selecting the distance of the suction side of the pump from the discharge point so short that the nanofibrillar cellulose flows from the container by the effect of the pump suction, or
pressurizing the nanofibrillar cellulose in the container to such a pressure that it will flow at the selected distance of the suction side from the discharge point by the common effect of the pressure of the nanofibrillar cellulose and the pump suction.

2. Method according to claim 1, wherein before unloading, the container is tipped so that the discharge point becomes the lowermost point with respect to the volume of nanofibrillar cellulose in the container.

3. Method according to claim 1, wherein the inner volume of the container tapers towards the discharge point.

4. Method according to claim 1, wherein the nanofibrillar cellulose is pressurized by a gaseous pressure acting above the level of the nanofibrillar cellulose in the container.

5. Method according to claim 4, wherein the gaseous pressure is 1.5 to 4 bar absolute pressure.

6. Method according to claim 1, wherein the distance of the suction side from the discharge point is 0-10 m, 0-9 m, 0-8 m, 0-7 m, 0-6 m, 0-5 m, 0-4 m, 0-3 m, 0-2 m, or 0-1 m.

7. Method according to claim 1, wherein the distance of the suction side from the discharge point is 0-5 m, 0-4 m, 0-3 m, 0-2 m, or 0-1 m.

8. Method according claim 1, wherein the distance of the suction side from the discharge point is 0-1 m.

9. Method according to claim 4, wherein the distance of the suction side from the discharge point is 0-10 m, 0-9 m, 0-8 m, 0-7 m, or 0-6 m.

10. Method according to claim 1, wherein the discharge point and the suction side are connected by a pipe whose inner diameter is at least 50 mm.

11. Method according to claim 1, wherein the concentration of nanofibrillar cellulose is 2 wt-% or more.

12. Method according to claim 1, wherein the zero-shear viscosity of the nanofibrillar cellulose is above 5000 Pa·s. when measured at 1 wt-% concentration in aqueous dispersion.

13. (canceled)

14. Method according to claim 1, comprising
loading liquid dispersion of nanofibrillar cellulose into a container through a filling inlet,
transporting the liquid dispersion of nanofibrillar cellulose in the container to the destination, and
at the destination, unloading the liquid dispersion of nanofibrillar cellulose from the container in an unloading position through a discharge outlet which in the unloading position is at the end of a tapering portion of the container in the lowest position of the container.

15. The method according to claim 14, wherein the container is a tippable container where the unloading position is the tipping position where the discharge outlet is in the lowest position with respect to the inner volume of the container.

16. The method according to claim 14, wherein the discharge outlet is in the lowest position with respect to the inner volume of the container in the fixed position of the container

17. The method according to claim 15, wherein the container is transported in a tank truck, in a rail tank wagon, or as separate freight container.

18. The method according to claim 14, wherein the loading of the liquid dispersion of fibril cellulose into the container is performed by pumping the fibril cellulose from a container.

19. The method according to claim 14, wherein the loading of the liquid dispersion of nanofibrillar cellulose into the container is performed by pumping the dispersion through a filling inlet at the top of the container.

20. Apparatus for transporting nanofibrillar cellulose, comprising
a container containing nanofibrillar cellulose showing shear thinning behaviour and having zero-shear viscosity above 10000 Pa·s at the processing consistency in the container when determined by rotational rheometer, with a filling inlet and a discharge outlet, said discharge outlet being at the end of a tapering portion of the container and positioned or positionable at the lowest position with respect to the inner volume of the container,
a progressive cavity pump operating on a positive displacement principle,
a connecting hose connectable to the discharge outlet of the container and to the progressive cavity pump for pumping the contents of the container out of the container, whereby
the length of said connecting hose between the suction side of the progressive cavity pump and the discharge outlet being at the most 10 m, 9 m, 8 m, 7 m, 6 m, 5 m, 4 m, 3 m, 2 m, or 1 m, and/or
said container being provided with means for pressurizing the interior of the container.

21. The apparatus according to claim 20, wherein the container is part of a vehicle.

22. The apparatus according to claim 21, wherein the container is part of a tank truck or rail tank wagon.

23. The apparatus according to claim 22, wherein the container is a tippable container of a tank truck.

24. The apparatus according to claim 20, wherein the container is a movable freight container.

25. The apparatus according to claim 20, wherein inner diameter of the connecting hose between the progressive cavity pump and the discharge outlet is at least 50 mm.

26. The apparatus according to claim 20, wherein inner diameter of the connecting hose between the progressive cavity pump and the discharge outlet is at least 75 mm.

27. The apparatus according to claim 20, wherein
the length of said connecting hose between the suction side of the progressive cavity pump and the discharge outlet is at the most 10 m, 9 m, 8 m, 7 m, 6 m, 5 m, 4 m, 3 m, 2 m, or 1 m, and
said container is provided with means for pressurizing the interior of the container.

28. Method according to claim 1, wherein the nanofibrillar cellulose shows zero-shear viscosity above 20000 Pa·s at the processing consistency in the container when determined by rotational rheometer.

29. Method according to claim 27, wherein the nanofibrillar cellulose is pressurized by a gaseous pressure acting above the level of the nanofibrillar cellulose in the container.

30. Method according to claim 28, wherein the gaseous pressure is 1.5 to 4 bar absolute pressure.

31. Method according to claim 1, wherein the discharge point and the suction side are connected by a pipe whose inner diameter is at least 75 mm.
